(19) United States
(12) Patent Application Publication
(10) Pub. No.: US 2007/0193955 A1
(43) Pub. Date: Aug. 23, 2007

(54) Aquarium protein skimmer

(76) Inventor: Thomas E. Nelson, San Diego, CA (US)

Correspondence Address: Wesley B. Ames;Ames IP Law, 7031 Los Vientos Serenos, Escondido, CA, 92029, US

(21) Appl. No.: 11/361,863

(22) Filed: Feb. 23, 2006

(51) Int. Cl. A01K 63/04; C02F 1/24

(52) U.S. Cl. 210/703; 210/221.2; 119/263; 119/264; 210/167.26

(57) ABSTRACT

Injection-type protein skimmers are described, especially applicable to removal of protein contaminants from aquarium water.

### RELATED APPLICATIONS

NOT APPLICABLE.

### FIELD OF THE INVENTION

The present invention relates to bubble-type protein skimmers, especially for aquarium use.

### BACKGROUND OF THE INVENTION

The following discussion is provided solely to assist the understanding of the reader, and does not constitute an admission that any of the information discussed or references cited constitute prior art to the present invention.

Maintenance of water quality in aquaria is a consistent issue for aquarium owners. Protein skimmers are useful tools for maintaining acceptable water quality by oxygenating the water through the introduction of air bubbles into the water and by purifying the water by through the collection of certain contaminants at the air/water interface of the bubbles. The collected contaminants, especially proteins, lead to the formation of relatively stable foam. Separation of that foam from the water allows the contaminants to be removed from the water, thereby providing water purification.

In general, in order to obtain effective water purification, it is desirable to produce a large number of small air bubbles and provide extended interaction time between the bulk water and the bubbles.

A number of different protein skimmer designs have been described. For example, U.S. Pat. No. 5,554,280 describes protein skimmers of a type that can be referred to as a “downdraft” skimmer. This design generates bubbles by injecting a smooth-flowing, high-pressure stream of water through a long tube that contains special media designed create a froth with downwardly inducted air. The tube containing the media is typically three to five times the height of the body of the skimmer. This design also includes a main body box that separates the bubbles from the incoming water so that they can be gathered inside of a collection cup as dry foam. This type of protein skimmer is a quite efficient design, but has several disadvantages, including a requirement for a very powerful water pump in order to effectively generate bubbles, a generally large format, e.g., typically two to five feet tall, and relatively inefficient mixing resulting in less than optimal due to limited contaminant/water contact time and resulting limitations on skimming efficiency

Another example is U.S. Pat. No. 5,122,267 which describes a design that can be referred to as a “venturi” protein skimmer. Venturi skimmers, unlike the downdraft design, operate by generating bubbles via the venturi effect. Such skimmers typically require a special venturi valve apparatus and a very powerful water pump. Generally in such designs, water is forced through a venturi valve into the bottom of the body of the skimmer, where the bubbles then rise up a long column and form froth at the top. Typically venturi designs produce significantly few bubbles and less contaminant removal than downdraft design skimmers.

Yet another example is U.S. Pat. No. 5,665,277 which describes a skimmer that generates bubbles through the use of a strong air pump which forces diffused air directly into the body of the skimmer. Limitations of these types of skimmers include the need for a high output air pump, and a separate water pump.

Another design is described in Kim, U.S. Pat. Nos. 6,156,209 and 6,436,295 which can be referred to as a spray type skimmer. In this design, “an injector is used for spraying protein contaminated water into a water bubble chamber. The spraying motion causes bubble generation in the water bubble chamber.” The bubbles are effective to collect and remove dissolved proteins and other materials. “A hollow foam riser is attached to the top of the water bubble chamber and provides an exit pathway for the contaminated foam. As foam is generated, it rises through the foam riser and carries with it contaminates. A foam collection cup is attached to the top of the foam riser and collects the contaminated foam.” ('295 patent, col. 3, line 63 to col. 4, line 5.)

### SUMMARY OF THE INVENTION

The present invention provides a highly effective protein skimmer for purifying water by removal of protein contaminants. The protein skimmer is particularly useful for purifying aquarium water. This protein skimmer design utilizes an advantageous configuration of foam collection cup adjacent or proximal to a foam channel.

In particularly advantageous configurations, the skimmer incorporates an injector to forcefully inject a relatively smooth stream of protein-contaminated water into the water surface in a mixing or bubble chamber. The injection of the water stream generates bubbles in the water in the mixing (bubble) chamber and sets up deeper mixing that prolongs the contact time and mixing between the bubbles and the water that is being purified. In certain configurations, the contact time and mixing is further enhanced by including a secondary mixer in the water within the mixing chamber.

Thus, in a first aspect, the invention concerns a protein skimmer that includes a mixing (bubble) chamber that has perimeter walls, a foam exit channel at or near the top of the chamber, and a cleaned water exit at or near the bottom of the chamber. The skimmer also includes an injector configured to inject contaminated water into water in the mixing chamber and cause generation of bubbles in water therein. Adjacent to the foam exit channel is a foam collection cup that is arranged to accept foam rising through the foam exit channel. In certain advantageous embodiments, the water from the injector is injected into the surface of the water in the mixing chamber; the injector injects a smooth-flowing stream of water.

In particular embodiments, the mixing chamber has a generally rectangular horizontal cross-section; the injector directs the injected water such that a rotational circulation pattern is established; the bottom of the mixing chamber includes a dual angled or curved surface configured to assist the water circulation pattern and reduce passage of bubbles though the purified water exit; the upper portion of the mixing chamber includes an inclined surface oriented to deflect circulating water, e.g., toward a skim blade or generally to assist in establishing and/or maintaining the circulation pattern.

In certain embodiments, the protein skimmer includes a lid; the lid seals such that it creates separate air volumes about the injector and above the collection cup; the lid has two separate orifices with one above the injector and one above the collection cup or exit channel providing for passage of air; the separate orifices provide metering of intake and outlet air to control the amount of air flow volume into the bubble chamber and amount of air flow out the skimmer body; a vacuum channel connects air spaces above the collection cup and about the injector; the collection cup has a foam exit channel deflector (skim blade) attached.

In some embodiments, the skimmer includes a primary mixing chamber (bubble chamber) in which the water is injected and a secondary mixing chamber below the primary mixing chamber; in further embodiments there is a tertiary mixing chamber below the secondary mixing chamber.

In certain embodiments, the skimmer also includes a mixer mounted within the mixing chamber. Such a mixer can utilize a variety of different designs, e.g., a wheel, propeller, and the like. The mixer can be separately powered, or can be driven by the injected water, e.g., by impacting and rotating the mixer.

In certain embodiments, the protein skimmer includes a filter, e.g., a biological filter configured such that purified water from the purified water exit of the mixing chamber(s) passes through the filter. For example, the filter can be located adjacent to the mixing chamber.

In certain embodiments, as foam accumulates in the collection cup it can flow by gravity out a spout on that side of the cup and down to a secondary (usually larger) collection vessel. Such secondary collection vessel can be attached (e.g., removably attached) to the side of the protein skimmer body or can rest on a generally horizontal surface.

In yet another embodiment, the protein skimmer includes two separate protein skimmer functional units. In many cases, the functional units are sequentially linked. Each functional unit includes a separate injector, mixing chamber, and foam exit channel. The foam exiting through the foam exit channel may be collected in the same or different collection cups. A filter chamber having filter media may be functionally linked and/or located between the two functional units.

In a related aspect, the invention provides a protein skimmer kit that includes a protein skimmer as described above or otherwise described herein, and instructions for use of the skimmer or directions for obtaining such instructions (e.g., directions for obtaining instructions online, via mail, or other method).

In particular embodiments, the kit also includes a package that contains the protein skimmer and the instructions or directions. In such cases, the instructions or directions can be on the outside or inside of the package material, or can be a separate item contained within the container or attached to the outside of the container.

In connection with the present invention, the term “protein skimmer” refers to an apparatus in which dissolved proteins are removed from contaminated water, especially by adsorption of proteins onto the surface of suspended bubbles. In most cases, water from which at least some of the dissolved protein has been removed is returned to the source, e.g., to an aquarium.

As used in connection with the present protein skimmers, the term “bubble chamber” is used to refer to a region within the skimmer in which bubbles are created and/or mixed with bulk water. Typically, the bubble chamber and “primary mixing chamber” are the same.

In this context, the term “injector” refers to a component having one or a small number of openings (e.g., 2, 3, or 4 openings) for fluid passage, such that when water is pumped through the opening a forceful stream(s) is created. Such forceful stream(s) is distinct from a spray in which the water is dispersed, e.g., in droplets or multiple, dispersed, relatively small jets that do not provide as deep penetration into the bulk water as the same volume of water at same velocity in a single stream or even in a small number of smooth streams. Thus, the distinction between a forceful stream and a spray concerns the degree of dispersion rather than specifically the number of streams or jets. Generally creation of an aqueous spray is controlled by a combination of the water pressure and the shape of the orifice(s).

In connection with the present protein skimmers, the term “circulation” refers to a generally circular or elliptical rotational motion (e.g., vertically oriented rotation) of bulk water within a chamber, e.g., a primary or secondary mixing chamber. In such circulation, a fraction of the water may exit the circulation, e.g., move from a primary mixing chamber to a secondary mixing chamber.

In certain embodiments, the kit also includes a pump for pumping water through the injector of the protein skimmer.

Likewise, another related aspect concerns a method for removing protein contaminants from protein contaminated water by injecting contaminated water into water in a mixing chamber in a protein skimmer, where the injecting generates foam, passing the foam through a foam exit channel at or near the top of said mixing chamber, and collecting foam that passes through the foam exit channel into a separate collection tub located adjacent to the foam exit channel. In particular embodiments, the protein skimmer is as described herein.

Additional embodiments will be apparent from the Detailed Description and from the claims.

### BRIEF DESCRIPTION OF THE DRAWINGS

FIG. 1 shows a cross-section of an exemplary protein skimmer that includes a non-perforated foam collection cup and utilizes a set of deflector surfaces to direct water circulation within a mixing chamber.

FIG. 2 shows a cross-section of a second exemplary protein skimmer that includes two sequentially-linked protein skimmer units.

FIG. 3 shows a cross-section of an exemplary collection cup having an attached skim blade in place in the upper portion of a protein skimmer body.

FIG. 4 shows a cross-section of another exemplary collection cup design having attached skim blade, where the foam exit channel is on the opposite side of the injector from the collection cup.

FIG. 5 shows an exemplary single outlet injector nozzle installed on an elbow pipe.

FIG. 6 shows an alternative injector nozzle having a triplet nozzle tip.

FIG. 7 shows a cross-section of a collection cup with attached skim blades and foam exit channels.

FIG. 8 shows a cross-section of a collection cup in which the foam enters by spilling laterally over a lip that bears on one side of the foam exit channel boundary.

FIG. 9 illustrates an exemplary circulation pattern for a skimmer with a primary and a secondary mixing chamber where there is a two-angle deflector at the bottom of each chamber.

### DETAILED DESCRIPTION OF THE PREFERRED EMBODIMENTS

A variety of different protein skimmers are available for removing protein contaminants from aqueous solutions, and in particular from aquarium water. In general, such protein skimmers utilize bubbles passing through the water to be purified such that proteins and a number of other contaminants interact or adsorb at the interface of the bubbles. The bubbles, with associated contaminants rise through the water and form foam at the surface of the water. As the foam accumulates, it can rise through a passage above the water surface. In certain currently available designs, the passage extends through a port in the bottom of a collection cup with the walls defining the passage extending substantially above the bottom of the collection cup.

As described in the Background, a number of different methods have been used to generate the bubbles. However, an additional simple and highly effective design utilizes a surface injection effect. A relatively smooth flowing stream or jet of water is injected at a relatively high velocity into the surface of the water in the mixing chamber. This process generates a large number of small bubbles as air is entrained into the water by the passage of the injection stream(s). The injection further drives the bubbles deep into the bulk water in a high turbulence mixing regime, and also establishes bulk circulation that keeps bubbles deep in the water for substantial periods of time.

Eventually the bubbles rise through the water in the mixing chamber, leaving water at the bottom of the chamber that has been at least partially purified of suspended and solubilized proteins. Because water is continuously being added from the injector, purified water must be removed to maintain a relatively constant level. The purified water is allowed to exit the mixing chamber through a purified water exit channel at or near the bottom of the mixing chamber.

At the upper portion of the chamber, bubbles with adsorbed contaminants rise to the top of the circulating water. A foam deflector or skim blade skims the foam from the surface and directs it into a foam exit channel. At the top of the channel, the foam spills laterally, flowing into a foam collection cup.

A. Bubble/Mixing Chamber

The bubble chamber (also referred to as the primary mixing chamber) in the protein skimmer can be configured in various shapes and sizes. For example, the chamber may be rectangular, circular, hexagonal and other shapes in horizontal cross-section. Most often the chamber will be rectangular. In use, the chamber is partially filled (usually to near the top) with water in which a large number of small bubbles have been suspended. Water is essentially continuously injected into the chamber.

The top of the chamber typically has a portion that contains a foam exit channel, e.g., rectangular channel, extending from at or near the top of the chamber and toward the collection cup. The collection cup can be adjacent to the foam channel, or can be a short distance away with a lateral flow channel to carry the foam from the foam channel to the collection cup. In many cases, the collection cup will be removable, providing convenient emptying and/or cleaning.

For embodiments that utilize an injector stream-type bubble generation, near the top of the chamber above the surface of the water is an injector nozzle. Water to be purified is injected through the injector forcefully into the surface of the water. This injection produces turbulent mixing, while also typically producing circulation that carries bubbles deep into the bulk water in the chamber. Such circulation increases the residence time of the bubbles in the water of the chamber. Prolonging the residence time increases the opportunity and extent of contaminant adsorption at the bubble surface, thus increasing the efficiency of contaminant removal. The turbulent mixing and/or circulation is controllable, for example, by controlling the direction and force of the injection stream.

The circulation can be enhanced by proper direction of the injector stream. For example, the stream can be directed downward near one wall, such that a downward flow of water results below the stream impact region. As the water in that region sinks, it creates a corresponding movement of bulk water away from the sinking water, resulting in a corresponding rising water region on the opposite side of the chamber. Such circulation pattern can be further enhanced by the proper design and placement of baffles or deflectors as discussed below.

In general it is desirable to prevent bubbles from being carried from the primary mixing chamber through the purified water exit, because those bubbles will carry with them a portion of the contaminants. Thus, it is advantageous to place the purified water exit and/or baffles or current deflectors to direct bubble laden water away from the exit. Generally, the separation of bubbles from water can be improved by increasing the time in which the water is out of the mixing zone but still located such that bubbles rising out of that water are able to rise to the top of the bubble chamber (i.e., the water has not passed into a different water column).

1. Baffles

Baffles or deflectors positioned in the bubble chamber at the bottom of the volume in which mixing is to be maintained assist in directing the circulation of bulk water and/or create zones of low mixing which allow bubbles to rise and re-enter the mixing zone. Typically, such structures will both deflect the water circulation and create low mixing zones, but the relative effectiveness for each of those functions will depend on the shape, size, and positioning of the structure. Advantageously, a deflector or baffle is positioned to deflect the downward flow of water and transition the flow across the chamber and then up the opposite side of the chamber. That function can be made even more effective if the deflector includes at least one additional angle (e.g., at least two progressive angles or a continuous curve) that deflects the flow direction to an upward flow.

The separation will be more effective if the flow path includes an additional baffle(s). For example, such additional baffle can be a deflector extending from the opposite side with respect to the first baffle, placed substantially lower than the first baffle, such that a secondary mixing zone or chamber is defined between the opposing baffles. This zone will have reduced turbulence and circulation. Residence of water in this zone allows bubbles, including protein-laden bubbles to have additional residence time in the water and then to rise out of the secondary chamber back into the primary chamber. This results in improved purification efficiency. As with the first baffle or deflector, the second baffle can utilize an additional progressively angled surface(s) or curve at an angle to enhance the circulation effect.

The effect of including a secondary mixing chamber can be extended by defining a third mixing chamber utilizing a third baffle so that a zone is established between the second and third baffles such that still more bubbles can rise to higher mixing chambers and eventually escape and rise through the foam exit channel as foam. This is particularly true for very small bubbles which escape relatively slowly from the current of water exiting through the purified water exit opening or channel. Once again, the baffle may have an additional progressively angled surface(s) or curve to efficiently direct the water circulation within that mixing chamber.

Another advantageous design emphasizes the baffle function by including a generally perforated plate. Such a perforated plate essentially blocks mixing below the plate, allowing only the current of sinking water through the plate toward the purified water exit. However, the perforations should be of sufficient size and number that the water current through the perforations is not so fast that small bubbles will not overcome the current and rise through the plate. Thus, the perforated plate allows air bubbles to rise through the plate while largely stilling mixing currents below the plate. For example, such perforated plate can be used as the bottom baffle below the secondary (or last) mixing chamber, or can be incorporated in a system which itself slows bubble rise on the side opposite the injector stream. The perforated plate(s) can created micro mixing zones and slow the bubble rise rate.

However, with appropriate selection of injection volume, velocity, and direction, combined with sufficient depth of a mixing chamber, stable circulation patterns can be established even in the absence of baffles or diverters. In this case, the downward flow can be driven by a stream injection, with the injection displacing water deep in the bulk water volume. Such displacement creates a lateral flow region above a relatively stagnant zone. The lateral flow converts to upward flow as it encounters a wall of the chamber, assisted by the buoyant rising of the bubbles. The rising water and bubbles are then forced to move laterally when they approach the surface in the chamber, moving toward the injection area and continuing the circulation pattern.

Indeed, both in skimmers without deflectors at the bottoms of mixing chambers and in skimmers having such deflectors, more complex circulation patterns can be created. For example, two major circulation patterns can be created in a primary mixing chamber, e.g., by injecting approximately centrally in the surface of the bulk water, so that circulation patterns are set up on each side of the injection zone. In this case, it is possible to use skim blades at the surface of each circulation pattern to skim foam into separate foam exit channels. The foam can then be collected into separate collection cups or into a common collection cup (e.g., via separate entry channels).

2. Foam Exit Channel

As indicated above, at the top of the bubble chamber is a foam channel that allows the foam to rise toward the collection cup. In most current protein skimmers, the rise of the foam to the top of the water and its accumulation there forces the foam into a foam riser. The foam travels up through a perforation in the bottom of a collection cup as additional foam accumulates at the top of the water.

In contrast, in the present designs preferably the foam channel is defined by generally vertical walls, and the foam rises adjacent or proximate to a foam collection cup, spilling or being diverted laterally into a collection cup that does not have such bottom perforation. While simple rising action can force the foam into the foam exit channel, advantageously the design includes a diverter portion (projecting into the primary mixing chamber) that deflects and retains foam at the top of the circulating water, thereby enhancing the ability of the foam to rise through the channel. Such diverter portion is also referred to as a skim blade due to its function in skimming foam from the surface of the water in the primary mixing chamber.

Such effect can be further increased by vacuum assist, i.e., by creating a vacuum above the foam exit channel. While a vacuum pump can be used, a low level vacuum can also be obtained in other ways, e.g., by having a sealed top on the skimmer with separate spaces above the collection cup/foam exit channel and above the injector and having an air channel linking the two. In this design the injection action entrains air in the water which escapes the volume as foam, necessitating the entry of additional air through the air channel. This process creates a slight vacuum in the space above the foam exit channel. This slight vacuum assists in removal of foam through the foam exit channel and may be a beneficial factor in drying the foam. Generally, however, the protein skimmer will work without such vacuum assist. When a sealing top (e.g., sealing lid) is used without a vacuum channel, orifices can be provided allowing air to exit from the space above the foam exit channel or collection cup and to enter the space above or around the injector. The orifices for either or both of those spaces may be metered, allowing the quantity of air passing through the orifices to be controlled or regulated.

The foam channel deflector may be mounted in the body. In this design, all surfaces forming the foam exit channel or foam catching channel are generally attached to or directly mounted in the body. In an alternative, the foam channel deflector is attached to the foam collection cup. In either embodiment, the connection of the foam channel deflector can be fixed (e.g., glued) to the body or the collection cup, or may be movably attached such that its position can be vertically adjusted (e.g., a slidable friction fit).

In many embodiments, the foam channel deflector is positioned essentially vertically and is a straight blade section. However, in some designs, it will be desirable to orient at least the bottom portion of the deflector such that it points into the water flow (rather than in the direction of the water flow). Such orientation may be accomplished by angling the entire deflector or by using a deflector that has an angled or curved lower section. Orienting the lower portion of the deflector in this manner can cause the foam to be more effectively directed into the foam exit channel.

3. Mixer

Certain embodiments include a secondary mixer in the bubble chamber. Such mixer assists in the creation of small bubbles without preventing a current from being established in the mixing chamber. Thus, advantageously the mixer is a rotating wheel or blade type mixer, where the injected water impacts the wheel or blades. Alternatively, more vigorous mixing and small bubble creation can be provided with a separately powered mixer. Such powered mixer can be driven by any of a variety of motors, including, for example, air-driven, water flow-driven, and electric motors. As an example, water that is to be injected or otherwise delivered into the skimmer can be used to drive the mixer motor before being injected, sprayed, or otherwise delivered into the skimmer. Such powered mixers can be particularly advantageous for skimmer designs that do not utilize forceful injection of a relatively smooth stream of water in order to assist in creating a consistent bulk water circulation pattern.

Certain embodiments include a secondary mixer in the bubble chamber. Such mixer assists in the creation of small bubbles without preventing a current from being established in the mixing chamber. Thus, advantageously the mixer can be a rotating wheel type mixer, rotating blade, or other type of rotating structure configuration, where the injected water impacts the wheel or blades, or paddles. In addition, a mixer may have paddles and be located such that its spinning will create or assist in creating a lateral flow of surface water/foam towards the skim blade.

Alternatively, more vigorous mixing and small bubble creation can be provided with a separately powered mixer. Such powered mixer can be driven by any of a variety of motors, including, for example, air-driven, water flow-driven, and electric motors. As an example, water that is to be injected or otherwise delivered into the skimmer can be used to drive the mixer motor before being injected, sprayed, or otherwise delivered into the skimmer. Such powered mixers can be particularly advantageous for skimmer designs that do not utilize forceful injection of a relatively smooth stream of water in order to assist in creating a consistent bulk water circulation pattern and/or to drive surface flow toward a skim blade.

4. Water Recycler

In order to further improve the purification, water can be recycled within the protein skimmer. This can be particularly advantageous where it is desirable to utilize a low flow rate through the skimmer, while still retaining a strong injection action. This can be accomplished by pumping unpurified water from the tank and purified or partially purified water from within the protein skimmer through the water stream injector(s) or through separate injectors. The recycling draw can be from any point, but will usually be from a point past the primary mixing chamber, e.g., within a secondary or tertiary mixing chamber or from an opening, aperture, or passageway at the entry or exits from such chamber, or from within the purified water exit pathway, or from the stream after it exits the protein skimmer body.

The pumping can utilize the same or separate pumps. Where one pump is used, the fluid draw from each source can be pumped by a single pump or separate pumps. For the single pump design, the draw from each source can be metered (either fixed metering or using an adjustable valve(s) to provide a desired mix, e.g., using a metering valve(s) on the inlets. When using separate pumps, the outputs can be directed through a common spray injector or through separate injectors; if desired the flow from one or both pumps can be metered.

Alternatively, the recycling water can be re-processed through a secondary protein skimmer, which can be a separate unit or can be combined with the primary protein skimmer in a single unit. In most cases, such separate unit will utilize a separate water pump.

B. Injector

For injection type protein skimmers, a large number of different injector designs and placements can be utilized, but preferably the injector provides a forceful stream of water sufficient to cause significant air entrainment and turbulence as it enters the bulk water, and preferably drive bulk circulation. The water jet from the injector can be injected as a single stream or as multiple streams. The size of the injector nozzle opening can be varied in conjunction with pump capacity to produce the desired fluid velocity. In many cases, the stream velocity will be about 1-50 meters per second, e.g., 1-2, 2-3, 3-5, 5-10, 2-20, 20-30, 30-40, 40-50, 20-50 meters per second.

For example, using an orifice diameter of an exemplary injector of 0.125″; when used with a 295 g.p.h. rated pump, the resulting stream velocity was approximately 8 meters per second. This strong injection creates the circulation in the bulk water, which results in lateral movement of the surface water. With this exemplary injector/pump combination (as with other pump injector combinations), the circulation rate can vary considerably depending on the volume and configuration of the mixing chamber. For example, the pump/injector combination was observed to produce a rotation rate of about 1.5 rotations per second in an exemplary skimmer. Such rotation produces water surface velocities of about 1 meter per second for a circulation pattern having an outer circumference of about 0.7 meters. The rotation rates in the mixing chamber can be selected or designed to produce a broad range of circulation rotation rates, e.g., about 0.5-5 rotations per second (30-300 revolutions per minute). Thus, in particular embodiments, the average lateral flow rate of the water in the upper 2 cm at a point 3 cm in advance of the skim blade is 0.2-3.0 meters/sec (or at least 0.2, 0.3, 0.4, 0.5, 0.7, 1.0, 1.5, 2.0, 2.5, 3.0, 0.2-0.5, 0.5-1.0, 1.0-2.0, 2.0-3.0 meters/sec.).

The circulation rates will be affected by a number of factors. With a smaller mixing chamber the revolution rate would increase, consequently increasing the speed of the surface water. Advantageous injection velocities will further be determined by the water volume of the mixing chamber, surface area of the water, depth of the water, and/or shape of the mixing chamber, as well as the injection velocity and flow rate. Such strong injection velocities cause entrainment of air/water into the mixing chamber, cause the desired circulation, and cause the surface water lateral movement useful to efficiently skim the contaminated surface water/foam with the skim blade.

The strong injection is also effective to drive the optional mixing wheel. Strong injection is needed to spin the wheel sufficiently to cause a powerful mixing in the mixing chamber to create highly frothy bubbles allowing for effective removal through the foam exit channel.

Such injector is distinguished from a spray nozzle or orifice which creates a spray rather than a relatively smooth stream. For example, the present injector design is distinguished from the spray design described in U.S. Pat. Nos. 6,156,209 and 6,436,295. As indicated above, preferably the stream is sufficiently forceful to drive the circulation in the mixing chamber. The injector may be as simple as a section of tubing or pipe that directs a stream of water toward the surface of the bulk water.

The placement of the injector can be adjustable, including adjustment of either or both of injection angle (stream direction) and distance to the water surface. In addition, the injector can be designed such that the injector nozzle can be changed, e.g., to change the orifice size and/or shape. Such nozzle change can also alter the stream velocity.

The distance from the injector tip to the water surface has been found to affect the extent of bubble formation and resulting foam formation. In many cases, a distance of 2.5 cm or less (e.g., no more than 0.5, 1.0, 1.5, 2.0 cm) will be effective. Greater bubble formation can be obtained by raising the injector higher above the water, e.g., to 2.5-4.0, 4.0-6.0, 6.0-8.0, 8.0-10.0, at least 5, or at least 7.5 cm. In tests of an exemplary system, simply raising the injector from 2.5 to 7.5 cm above the water dramatically increased the amount of foam produced. Thus, the elevation of the injector can be varied to produce a desired amount of foam and/or to functionally match with the handling capacity of the foam exit channel and/or foam collection cup.

An additional advantage of the stream injector method as compared to a spray device is a reduction in the resulting noise level. The distributed high velocity spray produces substantial noise when it hits the surface of the bulk water, while the noise produced by a relatively smooth stream is significantly lower. Thus, for example, the noise produced by the present skimmer (exclusive of the water pump noise) can be reduced by at least 3, 6, 9, or more decibels (dB) compared to operation of a protein skimmer having a spray nozzle producing a fan spray pattern at the bulk water surface having a width of 1.5 to 2.0 inches and thickness of 0.2 to 0.5 inches for skimmer having the same wall thickness and composition and the same flow rate through the spray nozzle and injector nozzle respectively based on a spray velocity of 10 ft/sec.

C. Collection Cup

Typical protein skimmers have some type of foam collection cup, usually a cup that has a port penetrating the bottom of the cup through which the foam enters the cup. For example, U.S. Pat. Nos. 6,156,209 and 6,436,295 describe protein skimmers that include collection cups that have a hollow foam riser attached to the bottom of the cup with the riser extending into the cup as a walled port penetrating the bottom of the cup. The port is relatively centrally located and the bottom of the port forms the highest portion of the chamber. As a result, bubbles rising in the mixing chamber accumulate below the port opening as foam, and such accumulation forces the foam up through the port.

In contrast, the present collection cups do not use such a port penetrating the bottom of the cup. The absence of such a port simplifies the construction, emptying, and cleaning of the cup.

In many embodiments, the cup is adjacent to the foam channel and is removable, and the top of the foam channel and/or the adjacent foam channel is shaped to inhibit penetration of the foam between the cup and the body of the skimmer. The adjacent edge of the cup and/or the edge of the foam channel boundary plate can include a lip and/or a flow diverter that directs flow of the foam away from the edge of the cup. This can be enhanced by constructing the foam channel and collection cup such that the adjacent wall of the collection cup slips beneath a lip on the adjacent surface of the foam channel boundary. Such a construction reduces the potential for foam entering between the collection cup and the adjacent surface.

Further benefits in reducing the potential for foam entering between the collection cup and adjacent surfaces, e.g., side walls of the body, can be obtained by using lateral foam diverters (especially in conjunction with a lip on the foam channel boundary) which direct the foam away from the collection cup sides and any gap between the collection cup and body.

As indicated above, in certain embodiments, the foam channel deflector is attached to the collection cup. In this design, the foam channel deflector is connected to the collection cup such that insertion of the cup in the body positions the foam channel deflector to form the contaminated foam catching channel, e.g., with side walls being part of the body side walls, and the wall opposite the deflector being provided by the upper portion of the divider. Alternatively, the wall opposite the foam channel deflector may be the adjacent wall of the collection cup. In this case, it is desirable to provide a seal between the bottom of the collection cup and the surface forming the upper portion of the primary mixing chamber to prevent foam from leaking under the cup.

Alternatively, the foam channel deflector is attached to one side of the cup, and the opposite side of the foam exit channel is formed by the outside of the cup or by a second plate attached to the cup such that the deflector and the second plate provide opposing surfaces of the foam exit channel. The second plate can be connected with the proximal wall of the cup such that a downwardly opening U-shaped section is formed that can slip over the upper portion of the primary mixing chamber divider.

In additional embodiments, the collection cup placement is such that foam can enter the cup from two separate foam exit channels, e.g., from opposite ends of the collection cup. In an exemplary such design, the collection cup includes flanges or ledges that rest on the top of the proximal side of each foam exit channel; such contact may include a resilient sealing material, e.g., an elastomeric material.

1. In-Flow Channel

In some embodiments, the collection cup is located immediately adjacent to the foam channel such that the foam spills from the channel into the cup. In other embodiments, the collection cup is located slightly further away from the channel. The foam enters an in-flow (lateral flow) channel and travels laterally (and optionally downwardly) into the collection cup. Such lateral flow channel can be closed, or can be an open trough.

2. Out-Flow Spout

In certain embodiments, the collection cup simply accumulates the foam. Accumulated foam is generally removed from the cup, e.g., by removing the cup and dumping or washing the foam out of the cup.

In other embodiments, accumulated foam flows out of the cup through an out-flow spout. Such out-flow spout typically empties outside the body of the skimmer, e.g., into a collection vessel. Such vessel can be attached to the skimmer body or can rest on a horizontal surface, e.g., a surface on which an aquarium rests.

Alternatively, the accumulated foam can pass directly to an external vessel. In this arrangement, the foam travels laterally through a trough or channel outside the skimmer body. In certain embodiments, passage into the external vessel can be vacuum assisted, e.g., as described for an internal collection cup.

D. Filter Chamber

In certain embodiments, the present protein skimmer is configured as a dual function device, including both the protein skimmer and a filter unit. Such filter unit can use any of a variety of filter media. In certain embodiments, the filter media provides a biological filter media. A number of such dual function units have been described, and the present units can similarly utilize filter media. For example, a biological filter can be included after a protein skimmer in a single skimmer system, after the second skimmer unit in a dual skimmer unit system, or after the first skimmer unit in a dual skimmer unit system.

E. Exemplary Embodiments

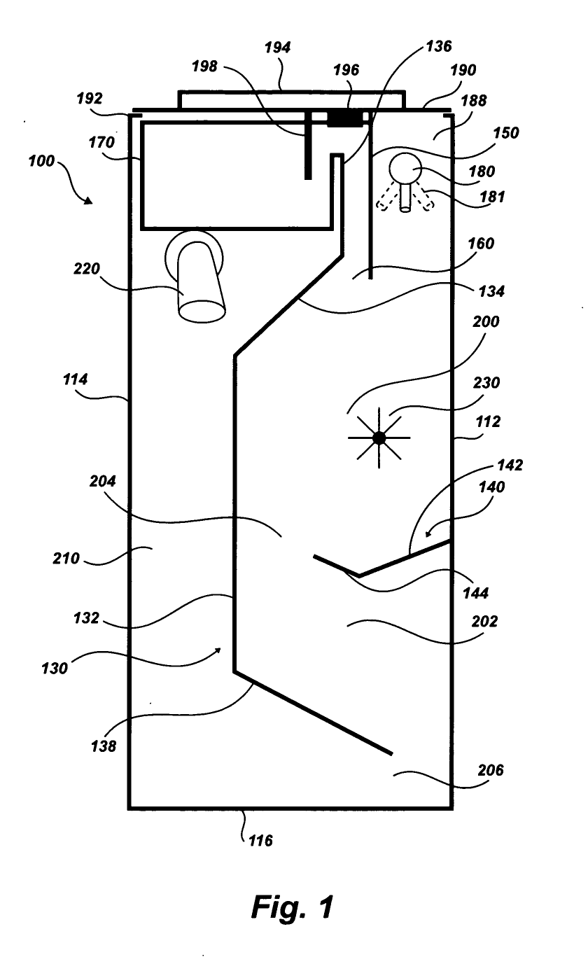

A cross-sectional view of an exemplary protein skimmer is shown in FIG. 1. This protein skimmer is designed to hang on a wall of an aquarium, although other placements can also be used, e.g., in a sump or stand-alone. The protein skimmer 100 has an outer body that is sealed along the bottom and sides to form a container with an optional removable top 190. The body includes front wall 112, back wall 114, and bottom 116. A divider 130 separates the interior of the body between mixing chambers 200 and 202 from the purified water exit pathway 210. Divider 130 includes several different sections, including primary divider section 132; continuing at the top of the primary divider section is upper divider deflector 134, which transitions to a generally vertical foam channel divider section 136. At the lower end of the primary divider section 132 is the lower divider deflector 138.

Extending from the front wall 112 partway toward central divider section 132 is the first directional deflector 140, which includes a down-angled first deflector section 142 and can also advantageously also have an upwardly angled second extension deflector 144. Generally paralleling the foam channel divider section 136 and nearer the front wall 112 is foam channel deflector 150 such that a foam catching channel or foam exit channel 160 is defined between them.

Adjacent to the top of the foam catching channel 160 is collection cup 170.

The protein skimmer also includes an adjustable injection nozzle 180 with nozzle tip 181 that is located in the upper portion of the body between foam channel deflector 150 and front wall 112, with the nozzle aperture directed generally downward. The nozzle connects with appropriate pipe or tubing from a water pump that pumps water to be purified from the source (e.g., an aquarium) through the injection nozzle.

Advantageously, the protein skimmer includes a removable lid 190 fitting onto the body, which can include a seal 192 (e.g., an elastomeric seal) and can further include a vacuum channel 194 connecting from above the collection cup to above the injection nozzle 180. The seal separates the air space above the collection cup from the air space above the injector. The vacuum channel connects to orifices opening into the space above the collection cup and into the space above the injection nozzle. One or both of those orifices can be valved to allow regulation of the airflow into the space above the injector and/or out of the space above the collection cup. Such valving and/or other airflow control can be used in either the presence or absence of the connecting vacuum channel. In this embodiment, the lid includes on its underside above the foam catching channel 160 a foam deflector 196, and a 2^{nd} foam deflector 198 positioned such that it creates a downward channel that connects between the foam catching channel and the collection cup.

On the opposite side of the skimmer, at the top of the purified water exit 210 but typically below the collection cup is purified water exit port 220.

Optionally, the mixing chamber 200 also contains a mixer 230 that has a plurality of blades.

In use, contaminated water, e.g., from an aquarium, is pumped forcefully through injection nozzle 180 located in air space 188. The downwardly directed water jet(s) are injected into the surface of bulk water filling the mixing chamber 200 creating a very large number of small bubbles within the bulk water. The water jet is directed generally down along the front wall 112. If optional mixer 230 is present, the jet is directed such that it significantly impacts the mixer, creating additional turbulent mixing and dividing larger bubbles into smaller bubbles. The flow of water downward along the front wall encounters 1^{st} directional deflector 142 such that the flow direction is directed across the mixing chamber and slightly upward. The majority of the water flow passes across primary mixing chamber opening 204 toward primary divider section 132, while a small fraction of the water passes through that opening into the secondary mixing chamber 202. Upon encountering the primary divider section, the flow direction is further transitioned upward toward the upper divider deflector 134 which deflects the flow at an angle toward the lower lip of the foam channel deflector 150 and the front wall 112. The upper divider deflector may include a single angle, or two or more angles, or even a smooth continuous curve. The water flow re-enters the region where water is injected and again flows down along the front wall, continuing the circulation pattern.

The presence of the small bubbles in the water in the primary mixing chamber allows protein and other contaminants to adsorb to the bubble interface. Bubbles to which a substantial amount of protein has adsorbed are relatively stable when exposed to air, and so will persist as surface foam for a significant period of time. As the contaminant-laden bubbles are carried in the circulating water. A percentage of the bubbles will be impeded by the foam channel deflector (skim blade) 150 such that the stable bubbles will rise as foam up through the foam catching channel 160. At the top of that channel, the foam encounters foam deflector 196 and is directed toward the collection cup 170, encountering foam direction deflector 198, at which point it is deflected down into the collection cup where it accumulates and dries. The accumulated foam can be cleared from the collection by removing the cup from the skimmer and removing the foam.

The action of the foam rising up the foam catching channel and passing ultimately into the collection cup can be assisted by a vacuum created in the collection cup. A low level vacuum can be created using a vacuum channel 194 that is an optional part of the lid 190, along with a seal 192 between the lid and the body of the protein skimmer. The vacuum is created because air is sucked through the channel into the space 188 above the injection nozzle 180. This occurs because air is continuously entrained into the bulk water by the injection action.

As indicated above, a portion of the water from the primary mixing chamber 200 exits the circulation loop through the primary mixing chamber exit opening 204 and enters secondary mixing chamber 202. This secondary chamber provides a less turbulent mixing regime which allows bubbles that have been carried into the secondary chamber to escape back into the primary mixing chamber 200. (Residence in the secondary mixing chamber also provides additional contact time between the bubbles and bulk water, thereby allowing additional contaminant removal.) Some of the rising bubbles will also become trapped under the down sloping portion of the 1^{st} directional deflector 140. Those bubbles may remain trapped for a significant period of time, with continuing adsorption occurring at the liquid bubble mass interface, but will eventually be carried with the bulk circulation in the secondary chamber and escape back through the opening 204 between the primary and secondary mixing chambers into the primary mixing chamber or re-enter the circulation in the secondary mixing chamber for additional contact/adsorption time before rising through the opening back into the primary mixing chamber. The result is that more contaminants will be removed and few bubbles will be carried with the purified water.

Water from the secondary mixing chamber primarily exits the chamber by passing through purified water outlet opening 206, passing into purified water exit pathway 210. As water continues to enter the purified water exit pathway, it rises and exits the skimmer through purified water exit port 220. Typically, the water then re-enters the aquarium. Of course, some fraction of the water in secondary mixing chamber 202 will re-enter primary mixing pathway 200, but will subsequently again pass into the secondary mixing chamber and progress on out of the skimmer.

Optionally, at least a portion of the purified water exit pathway 210 can be filled with a filtration medium (e.g., biological filtration medium). When present, such filter converts the protein skimmer into a dual function, protein skimmer/filter apparatus.

In a related design, the protein skimmer includes two separate but usually functionally linked protein skimmer functional units. Each functional unit includes a separate injector, mixing chamber, and foam exit channel. Thus, in generally terms each functional unit includes the components of a protein skimmer as described herein, some of which may be shared between the two functional units. For example, the foam exiting from a primary mixing chamber will rise through a foam exit channel and then be collected in either a common collection cup, separate collection cups, or separate chambers of a dual collection cup. A filter chamber having filter media may be functionally linked and/or located between the two functional units. In devices of this nature, the components in each functional unit can be distinguished by identifying the respective components as first unit or second unit components respectively.

The sequential linkage is accomplished by passing purified water exiting the first functional unit through a water pump, through an injector(s) into the second unit primary mixing chamber. For example, the output from the first unit can flow into a sump or reservoir. Such sump or reservoir can include or be linked with a filter, e.g., a chamber including filter media. The output from the second functional unit can then be returned to the aquarium or other source of contaminated water.

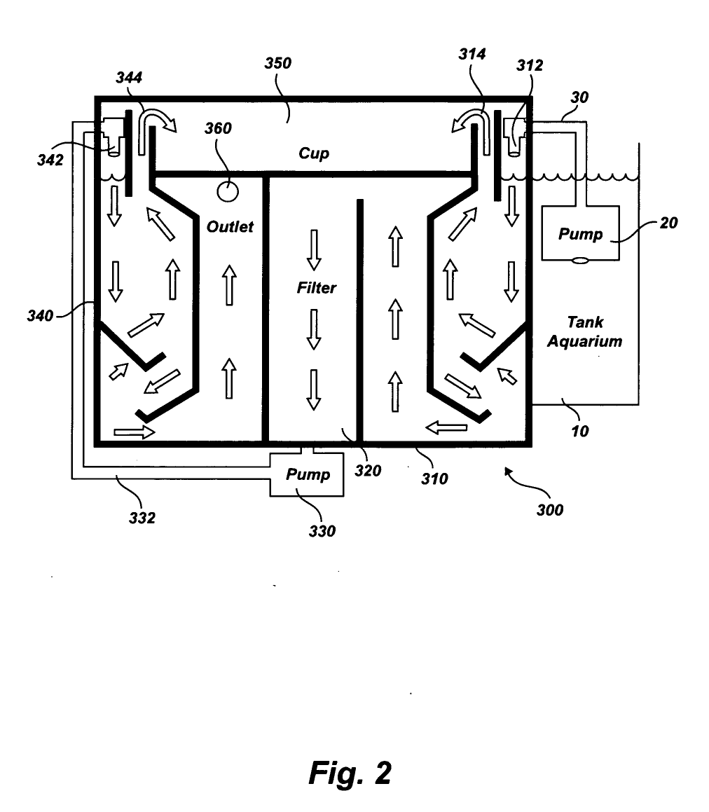

An exemplary dual protein skimmer unit design is illustrated in FIG. 2. Each of the skimmer units is configured similarly to the protein skimmer illustrated in FIG. 1, except that a single, dual inlet collection cup is used, along with a central chamber (which can be a filter chamber) between the protein skimmer units. Therefore, the components defining the mixing chambers and purified water exit channels are not repeated here; instead only components distinguishing the dual skimmer unit design from the single skimmer unit design are discussed here. FIG. 2 is not drawn to scale. The system including dual skimmer unit 300 includes a water pump 20 that pumps water to be cleaned from aquarium 10 through line 30 and then through injector nozzle 312 in first skimmer unit 310, which is constructed as described for FIG. 1. After passing through the first skimmer unit, the water passes into a central chamber 320 which optionally contains a filter media (e.g., a biological filter media). The water exits the central chamber into a pump 330, which pumps the water through line 332 into second skimmer unit 340 through second injector nozzle 342. Foam generated as described for the protein skimmer of FIG. I through foam exit channels 314 and 344 into opposite ends of collection cup 350. After passing through the second skimmer unit, purified water exits through purified water outlet 360 and returned to the aquarium tank (return not shown). Similar units may be constructed without the central chamber, such that water passes directly from the first skimmer unit into the pump and then through the second injector nozzle into the second skimmer unit. As described for the skimmer of FIG. 1, purified water can pass through a filter, e.g., a biological filter, after exiting from the second skimmer unit. Such filter can be in a chamber adjacent the second skimmer unit.

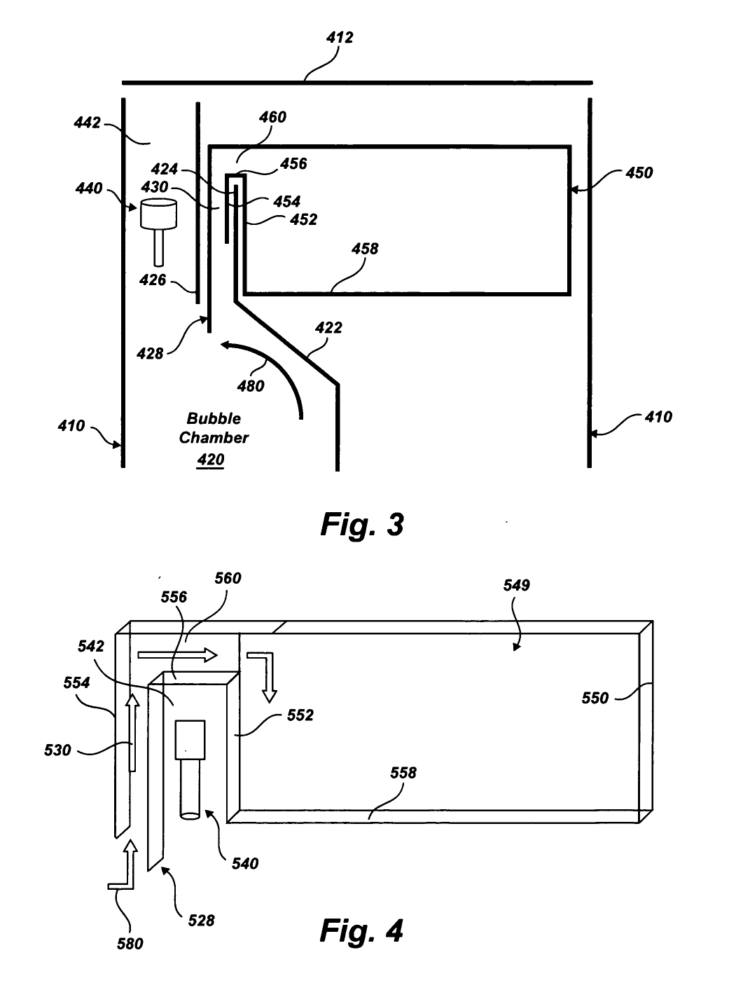

An embodiment of a collection cup with attached foam deflector (skim blade) is shown in FIG. 3 in place in a protein skimmer body (partial body shown). As shown, skimmer body 410 includes mixing (or bubble) chamber 420, with upper divider deflector 422 connected to foam exit divider 424, and injector air space separator 426 such that injector 440 is within the air space 442. In this design, the foam exit deflector 428, lateral connector 456, and down plate 454 are attached to the collection cup 450 which includes bottom 458 and proximate wall 452. Together, foam exit deflector 428, foam exit divider 424, and down plate 454 (along with lateral surfaces not shown) define the foam exit channel 430. Advantageously, the gap between proximate wall 452 and down plate 454 is sized to provide a slip fit to foam exit divider 424, and skim blade 428 is positioned to provide a slip fit with injector air space divider 426. The collection cup can be adjusted vertically to provide vertical adjustment for foam exit deflector (skim blade) 428. In this design, the circulation of bulk water in the mixing chamber 420 is in the direction shown by arrow 480 such that foam at the surface is skimmed by foam exit deflector 428 and directed up foam exit channel 430, flowing laterally through space 460 over lateral connector 456 and into collection cup 450. Vacuum connection can be provided as described for the skimmer illustrated in FIG. I by providing sealing for lid 412 and a vacuum channel between air space 432 and the interior of collection cup 450.

Yet another embodiment of a collection cup similar to that shown in FIG. 3 is illustrated in FIG. 4, but in which the foam exit channel 530 is further from the collection cup 459 (defined by front wall 552, back wall 550, bottom 558, and side walls not shown) than the injector nozzle 540. Here lateral connector 556 extends over the injector air space 542 containing injector 540, forming the bottom of lateral flow channel 560 and connecting to foam exit deflector 528. Down plate 554 can be attached to the collection cup or can be a body wall or a plate in the skimmer body. The foam exit deflector 528 and down plate 554 together define foam exit channel 530 (along with side surfaces not shown). In this design, the circulation flow in the mixing chamber is preferably reversed from that shown in FIG. 3, with the bulk circulation in the upper part of the mixing chamber moving in the direction shown by arrow 580. As with the collection cup of FIG. 3, the foam exit deflector 528 can be adjusted vertically by moving the collection cup vertically.

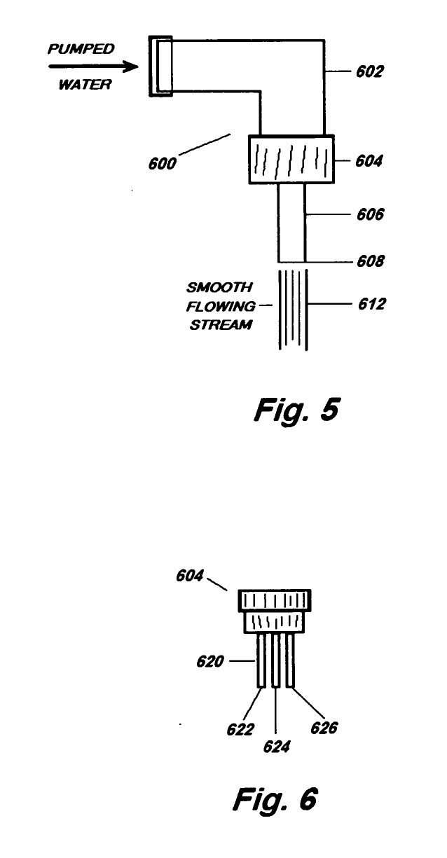

Exemplary injection nozzles are shown in FIG. 5 and FIG. 6. FIG. 5 shows a single outlet injector nozzle 600 attached to an elbow pipe 602. The injector nozzle includes a retainer ring 604 and nozzle tip 606 with a relatively smooth stream 612 being emitted. The nozzle tip has a straight tubular section with a single, non-constricted circular aperture 608. An alternative injector nozzle is shown in FIG. 6, with retainer ring 604, but with a triplet nozzle tip 620 is shown. The triplet nozzle tip has three parallel tubular sections 622, 624, and 626, each having a single, non-constricted circular aperture. Each of the tubular sections will emit a relatively smooth stream of water.

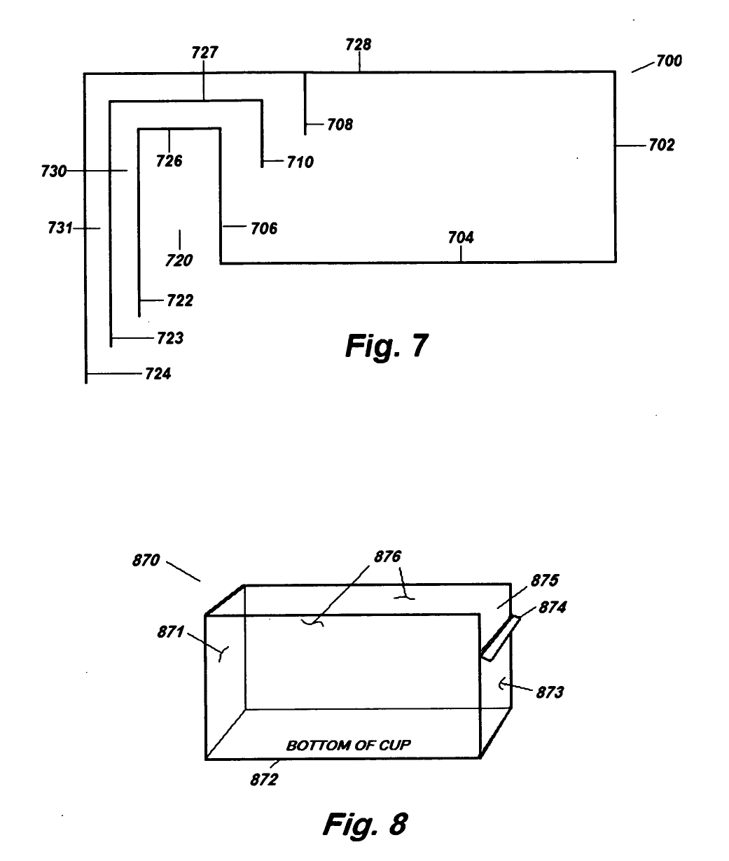

An additional collection cup embodiment is illustrated in FIG. 7. FIG. 7 shows a collection cup with attached dual skim blade design. Thus, the collection cup 700 includes a back wall 702, bottom 704, and front wall 706. The front wall separates the cup from the extension gap 720. The front of the collection cup connects to a lateral extension that includes extension floor 726 and intermediate extension divider 727. The lateral extension connects to the foam channel wall 722 that forms the remaining side of the extension gap. Spaced apart but parallel to the foam channel wall 722 is a first foam channel deflector (skim blade) 723; the space between is the first foam exit channel 730. Spaced apart and parallel to the first foam channel deflector is a second foam channel deflector 724 forming a second foam exit channel 731 between. The blade section would be positioned such that the foam channel divider would be just above the surface of the water, such that it does not skim appreciable foam, but with the first foam channel deflector at or just below the surface of the water. The second foam channel deflector would then be deeper into the water. Foam laden water circulates from the direction of the collection cup body toward the deflectors; the first deflector will typically skim the majority of the surface foam, while the second deflector skims foam that escapes under the lower edge of the first deflector and foam that is originally below the surface of the water. Foam rises through the foam exit channels, flows across the extension, and is deflected down into the collection cup by the optional first and second diverters 708 and 710. Diverter 708 is attached to the lower surface of lid 728, while diverter 710 is attached to the intermediate extension divider 727. In this design, the diverters and the intermediate extension divider are optional. Similar multiple skim blades can be incorporated in other designs, e.g., in the skimmer designs shown in FIG. 1, FIG. 3, and FIG. 4. This design can be used with the injector nozzle placed adjacent to the longer skim blade or can be adapted to over nozzle foam flow with reversal of the length order of the skim blades.

FIG. 8 shows the basic collection cup 870 similar to that illustrated in the skimmer of FIG. 1. The cup has back wall 871, bottom 872, front wall 873, and side walls 876. Projecting from the upper edge of the front wall is lip 874, defining a foam entry opening or throat 875. Foam rising through the foam exit channel spills laterally through the foam entry opening into the collection cup for drying and/or later removal.

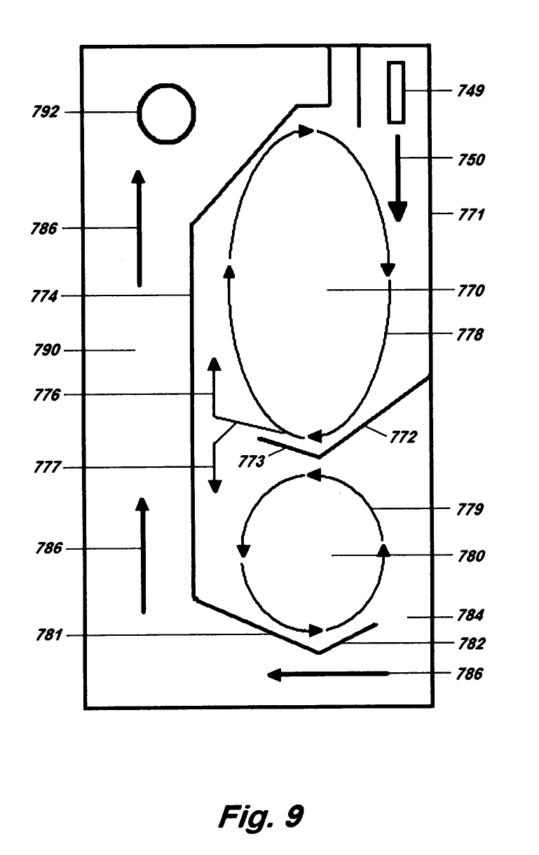

A more detailed schematic illustration of an exemplary bulk water circulation pattern within a skimmer with a primary and a secondary mixing chamber is shown in FIG. 9. Injector 749 delivers water injection 750 directed into bulk water in primary mixing chamber 770 down along front wall 771. Bulk flow continues downward until it is deflected laterally with first deflector section 772, moving laterally until further deflected slightly upward by second deflector section 773. A major portion 776 of the flow deflects upward at rear wall 774, while another portion 777 deflects downward into secondary mixing chamber 780. In the illustrated primary mixing chamber, circulation continues upward, strongest along the back wall, but with the upward flow extending across the majority of the chamber. As the flow approaches the surface, the flow direction transitions to return toward the injector, completing circulation pattern 778. In secondary mixing chamber 780 the flow initially deflects downward along back wall 774 until it encounters the first lower divider deflector section 781 which deflects the flow laterally with the second lower divider section 782 deflecting the flow upward. A portion of the flow exits the secondary mixing chamber, and a portion remains in the circulation pattern, transitioning laterally back toward the primary mixing chamber, completing circulation pattern 779. The circulation pattern developed depends on the direction and force of the injection stream, as well as the size and shape of the mixing chamber. Thus, for example, in some cases the strongest upward flow will be more toward the center of the chamber in contrast to the illustrated pattern where the stronger upward flow is proximate to the back wall. In most cases, the upward flow occupies a larger portion of the volume than the downward flow. Water exiting through exit aperture 784 travels through purified water exit pathway 790 generally as shown by flow arrows 786, and exits the skimmer though exit port 792, e.g., for return to a linked aquarium.

The circulation pattern and circulation rate in each chamber can be modified or controlled in several ways. Relevant factors include but are not necessarily limited to) injection velocity and volume (drives the circulation in the absence of a powered mixer); depth of each chamber; relative dimensions of each chamber; length and angles of diverter sections for each chamber; size of aperture between the chambers; presence, absence, and location of a further flow divider projecting from the back wall and further defining the primary mixing chamber exit aperture (similar flow divider can also be placed at the secondary mixing chamber exit aperture).

F. Operation Discussion

While functioning of the various components and the overall flow of water and contaminants in the present device were discussed above, the following discussion provides further explanation and indication of advantageous features and characteristics for the present skimmers. Currently, most skimmers that hang on an aquarium wall have a removable foam tower with exit passageway attached to a collection cup with a port that passes through the cup bottom. These collection cups are removable from the associated exit chambers. The ability to remove these types of collection cups requires slight gaps between the inner walls of the foam exit chamber and the outer walls of the exit passageway/foam exit tower. These gaps (even the smallest gap will leak air/water) cause a loss of rising contaminated foam bubbles from the mixing chamber, which results in a loss of rising bubbles in the foaming exit tower leading to a reduction in the amount of contaminated proteins collected and removed.

Furthermore, because these skimmers do not have an effective means of recirculating bubbles escaping out the purified water exit back into the mixing chamber, they lose additional bubbles by passing escaping bubbles into the purified water exit pathway. This issue of loss of bubbles is significant because with less contaminated bubbles in the foaming tower, the flow of contaminants into the collection cup is reduced.

In addition, the contact time of air bubbles with the bulk water in these skimmers is not long enough to efficiently remove all of the various dissolved organic compounds removable by foam fractionation, as some of those organic compounds require up to about 2 minutes of contact time before they are effectively adsorbed on the bubbles for removal via foam fractionation. Therefore, what is needed is a more efficient skimmer with a system to prevent the loss of bubbles and/or to increase the contact time for the bubbles in the mixing chamber.

In the present design, the combination of a controllable mixing chamber and a sealed foam exit channel prevents the loss of bubbles. Additionally, the utilization of a mixing chamber with directional channels/baffles so arranged to create a circulation effect. This circulation effect increases the residence time of bubbles in the mixing chamber, thereby allowing for a higher quality of contaminated foam scum to be removed. In this design, a stream of contaminated water is directed through an injector nozzle to the first directional channel/baffle beneath the bulk contaminated water surface in the primary mixing chamber. The water stream is deflected within the mixing chamber thereby initiating a controlled circulation of the water carrying the bubbles.

The introduction of contaminated water into the primary mixing chamber causes air to be drawn into mixing area and mixing of air with contaminated water. The bubbles in the contaminated water cause proteins and certain other contaminants to adsorb to the bubbles surface, producing contaminant-laden bubbles to develop in the circulating water in the mixing chamber. The injector nozzle may be adjusted to provide a controllable directional flow of the contaminated water circulation in the primary mixing chamber to optimize the circulation in the mixing chamber to create a long bubble/bulk water contact time for protein contaminants to attach to the bubbles and form contaminated bubbles. A longer contact time between the bubbles and protein in the bulk water allow bubbles to be completely saturated with protein before leaving the mixing chamber and entering the foam exit channel.

The balance of the amount of contaminated water flow with the amount of air injected in the water has a significant role in the removal of proteins in skimmers. This chamber with the proper dimensions matching the flow rate of contaminated water into the mixing chamber creates a highly efficient means for removing protein contaminants from aquariums.

As indicated above, the bubbles are continuously circulated with the mixing chamber with new contaminated water being introduced into the chamber from the aquarium by the means of a pump which forces the contaminated water into the primary mixing chamber through an injector nozzle directed such that the water flow is deflected from the first directional deflector one across the primary mixing chamber exit opening toward the primary divider section and up to the upper divider deflector, thereby causing controllable circulation of the protein contaminated water. As the circulating water flows toward the contaminated foam catching channel, the foam channel deflector catches passing foam and deflects some of the contaminated foam into the contaminated foam channel, and pushes other bubbles back into the mixing/circulation area to allow additional adsorption of contaminants.

The overall circulation characteristics cause bubbles to remain within the mixing chamber longer. In addition, the second mixing chamber recirculates bubbles escaping in water exiting the primary mixing chamber back into that primary mixing chamber causing even more contact time. Observations indicate that on average bubbles remain in the mixing chambers for more than two minutes and often more than three minutes, and perhaps significantly longer. The second mixing chamber also acts as a way to keep bubble from reentering the aquarium.

Most aquarists do not like the micro bubbles entering the tank on aesthetic grounds, but, in addition, such bubbles add to the possibility of contaminants entering into the purified exit pathway and then reentering the aquarium. Thus the secondary circulation of water in the secondary mixing chamber provides for recovery of bubbles into the primary mixing chamber circulation pattern. As mentioned above, the circulation within the mixing chambers and the opportunity for recovery of bubbles from the exiting purified water increases the bubble/water contact time allowing for more organic contaminants to be removed through the foam exit channel. Of course, the result is that the purified water delivered back to the aquarium is cleaner.

In cases in which the mixing chamber is sealed with a lid and the lid (or other structure such as chamber wall channel) includes an air channel connecting between the volume above the top of the foam exit channel to the volume including the injector, a vacuum can be created because injecting water into the bulk water in the first mixing chamber removes air from above the bulk water, pulling replacement air through the connecting air channel. The low vacuum created above the foam exit channel assists in drawing contaminated foam thru the foam exit channel and allowing it to overflow into the collection cup. This vacuuming and the controlled air flow through the contaminated foam has a beneficial effect on the removal of protein contamination of fish aquariums by increasing the flow of contaminated foam through the foam exit channel, and also has the further benefit of causing the foam to dry faster. Still further, such vacuum action leads to more rapid “seasoning” of the skimmer, allowing a new skimmer to provide efficient contaminant removal in approximately 1-2 days instead of the period of up to about two weeks required by most other types of protein skimmers. The air (vacuum) channel can have an air filter to clean air between the collection chamber and the injection volume above the first mixing chamber. The vacuum channel (or other structure may have an opening (which can be controllable to regulate amount or even to stop introduction) to introduce fresh air.

In addition, the primary mixing chamber or both mixing chambers may have mixing blade(s) in such a chamber. The blades in the first chamber can be powered by the injection stream of contaminated water from the injector nozzle. The spinning of the blades causes the bubbles to be separated into smaller bubbles creating even more bubbles. The end result of the mixing blade addition is to ultimately create more frothy bubbles resulting in better and faster removal of contaminating proteins, i.e., a more efficient skimmer. The number of bubbles can, for example, increase the number of bubble up to about 2-, 3-, 4-fold, or more, with corresponding decrease in the average bubble size.

As discussed, the present design significantly increases the average residence time for bubbles in the bulk water. The residence time can be easily estimated by observation of small groups of bubbles in each mixing chamber. The circulating flow of the protein contaminated water causes the bubbles to suspend in the center of circular flow allowing for visual calculation. This generally circular flow is clockwise or counter-clockwise. The suspended bubbles get caught in the interior of the circulation flow and smaller vortices created by the circular flow of the chamber and drift within the center of the flow while still spinning with the flow. Visual observation reveals that bubbles commonly remain in the primary mixing chamber for 2 minutes or longer. Adding to the average residence time is the operation of the second mixing chamber.

The second chamber collects bubbles escaping from the primary mixing chamber. In most embodiments, the circulation in this chamber spins opposite to that in the primary mixing chamber. The opposite flow causes the bubbles in each chamber to mix together slowly. This slow exchange between the chambers causes the protein contaminated bubbles to stay in the pair of mixing chambers longer causing increased total contact time. Bubbles are commonly observed to remain in the second mixing chamber for over a minute, with the residence time depending on the circulation rate. (If a tertiary mixing chamber is present, some of the bubbles will circulate in the tertiary chamber for approximately another minute.) The result is an average contact time of about 2-5 minutes in many designs (e.g., 2-4, 3-5 3-4 minutes). In addition to retention of bubbles within the circulation flow in the secondary chamber, some bubbles become trapped in the trapped air section beneath the first directional deflector for relatively long periods of time, e.g., for many minutes and potentially up to hours, until the circular flow pulls them across the underside of the first deflector directing the bubbles back into the primary mixing chamber allowing for more contact time.

The contaminated water inlet zone (around the injection stream impact area but above the main circulation zone in the primary mixing chamber) also contributes to increased contact time by collecting and holding bubbles for substantial intervals, e.g., for close to a minute. Upon escaping from this relatively stagnant zone, the bubbles are then re-introduced into the circulating chambers.

Use of dual, sequential protein skimmers (i.e., having 2 units linked in series where each unit includes an injector with associated mixing chamber(s) can provide even greater bubble contact times, e.g., average cumulative contact times of 3-8, 4-8, 4-7, 4-6, 5-7 minutes or even longer.

The use of controlled circulation contrasts with the mixing in skimmers such as those described in U.S. Pat. Nos. 6,156,209 and 6,436,295. Those protein skimmers utilize turbulent (random) mixing created around a spray area (as contrasted to a stream injection spot). Such turbulent mixing does not provide any consistent manner in which bubbles are retained in the mixing chamber, but instead produces bubbles and associated turbulent mixing comparatively near the surface. (The depth of mixing is dictated primarily by the spray force per unit area and the spray volume.) In the case of a commercial embodiment of the skimmers described in the above patents, a fan-shaped spray is produced that is about 1-1.5 inches wide (about 2.5-3.8 cm) at the impact zone with substantial continued spreading below the water surface due to the angular spread of the spray. Such spreading of the spray over a substantial area means that the turbulent zone will not penetrate as deeply as the present smooth stream injection and the mixing will be dominated by turbulent mixing rather than a deep circulation pattern.

Observations indicate that the circulation induced in the present skimmers provides substantially greater residence time, e.g., about a 50% increase or more in residence time compared to typical spray-type injection. The result is that the present device removes a larger quantity of quality protein contaminated scum in a shorter amount of time. As described above, the efficiency can be enhanced using a mixer that increases the number of bubbles, thereby increasing the bubble surface area and consequently the adsorption and removal of contaminants.

In addition, the foam exit channel deflector can be adjustable to optimize contaminated foam skimming function. In particular, the controlled circulation of the contaminated water/bubbles in the mixing chamber causes the top surface of the water/bubble/foam/contaminants in the chamber to move laterally across the surface of the water. This movement of contaminated water, bubbles, foam, and floating contaminants across the surface allows for “true skimming” of the contaminated water. As this surface moves laterally towards the foam exit channel deflector (which can also be referred to as a “skim blade”) foam from the surface on the contaminated water is deflected into the foam exit channel. This skim blade can be adjusted to control the amount of contaminated surface water/foam to be skimmed and directed into the foam exit channel. Thus, uniquely and in contrast to other protein skimmers, the device literally involves skimming. The skim blade may be forward angled or forward curved at the bottom edge. Such forward angle or curve provides even more effective skimming of the protein contaminated foam and assists in directing the foam up the foam exit channel.

G. Additional Embodiments

In addition to the protein skimmers that include a foam exit channel adjacent to a foam collection cup, an injector that injects a relatively smooth stream of water into a mixing chamber, and a mixing chamber in which a circulation pattern of the bulk water is established, these components or properties can be utilized alone or in each pairwise combination in additional protein skimmers. While such protein skimmers can be constructed and used effectively, generally they will not be as efficient as protein skimmers incorporating all of the present features, and in many cases substantially less efficient.

For example, in certain embodiments, the collection cup with an adjacent foam exit channel is used in combination with a spray injector/mixing chamber combination as described in U.S. Pat. No. 6,436,295. Thus, the present collection cup/foam exit channel arrangement replaces the collection cup with a port penetrating the bottom of the collection cup. Such collection cup and foam exit channel can be used in a skimmer with other types of bubble generating components, e.g., those referenced in the Background. In such protein skimmers, a circulation pattern of the bulk water can be assisted with a powered mixer, e.g., powered by air flow, water flow (e.g., contaminated water being delivered to the spray injector, or electric motor.

Likewise, in certain embodiments, the present injector that injects a forceful, relatively smooth stream is used in a protein skimmer that has a collection cup with a bottom-penetrating port, e.g., a collection cup as described in the protein skimmers in U.S. Pat. No. 6,436,295. Such skimmers may also include a mixing chamber with bulk circulation as described herein.

Other embodiments include an arrangement in which a circulation pattern in the bulk water in a mixing chamber is established, e.g., by a combination of mixing chamber shape and mixer and/or water injection. Such mixing chamber circulation can be combined with the present injector and/or the present collection cup/foam exit channel.

In yet other embodiments, a protein skimmer can be constructed that utilizes a foam exit channel deflector (skim blade) in conjunction with any of a variety of other components. The skim blade is positioned with its lower edge at or near (e.g., just above or just below) the surface of laterally flowing, bubble-containing water. In such a configuration, bubbles with adsorbed contaminants will rise to the top of the water, forming a foam. As the water with foam flows past the skim blade, the skim blade “skims” the foam from the water surface and directs it up a foam exit channel or port. After rising through the channel or port, it can flow into a foam collection cup, e.g., a collection cup with a side entry or a bottom port collection cup. The lateral water flow may be created in various ways. For example, such flow may be at the surface of a chamber in which a vertically oriented circulation pattern is present. In certain alternatives, the lateral flow is flow through a channel. For example, bubbles may be created in a mixing chamber of any type. Overflow from the chamber can pass through a channel or trough in which the skim blade is positioned. Bubbles may be generated using the present injector type apparatus, but may also be generated using a spray-type apparatus, venturi-type apparatus, or other bubble generator, e.g., as indicated in the Background.

In yet other embodiments, the skimmer is adapted to be placed within an aquarium or other such water body container. For example, in certain embodiments, the outer wall of the skimmer body adjacent to the purified water exit channel is removed. With the skimmer body placed in an aquarium or other body of water, the aquarium or body of water actually becomes a part of the exit chamber. Similarly in embodiments in which the outer skimmer body adjacent to the injector or an outer wall of the bubble chamber is removed and the skimmer placed in proximity to the wall of the aquarium or other container, the wall of the aquarium or body of water container becomes part of the mixing chamber and assists in maintaining the water circulation.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the size and shape of the injector nozzle, as well as to the shape and materials for the skimmer body. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values or value range endpoints are provided for embodiments, additional embodiments are described by taking any 2 different values as the endpoints of a range or by taking two different range endpoints from specified ranges as the endpoints of an additional range. Such ranges are also within the scope of the described invention.

Thus, additional embodiments are within the scope of the invention and within the following claims.

What is claimed is:

1. A protein skimmer, comprising
a mixing chamber comprising perimeter walls, a foam exit channel at or near the top of said chamber, and a cleaned water exit at or near the bottom of said chamber;
an injector configured to inject contaminated water into water in said mixing chamber and cause generation of bubbles in water therein;
a foam collection cup adjacent said foam exit channel arranged to accept foam passing through said foam exit channel.

2. The protein skimmer of claim 1, wherein said water passing through said injector is injected into the surface of the water in said mixing chamber.

3. The protein skimmer of claim 1, wherein said mixing chamber further comprises a mixer.

4. The protein skimmer of claim 3, wherein water injected from said injector impacts and rotates said mixer.

5. The protein skimmer of claim 1, wherein said mixing chamber has a generally rectangular horizontal cross-section, wherein said injector directs the injected water such that a rotational circulation pattern is established.

6. The protein skimmer of claim 1, wherein the bottom of said mixing chamber comprises a dual angled surface.

7. The protein skimmer of claim 1, further comprising a foam exit channel deflector proximate to said injector and forming a side of said foam exit channel.

8. The protein skimmer of claim 1, wherein said mixing chamber, injector, and foam collection cup comprise a first skimmer unit, and said protein skimmer further comprises a second skimmer unit sequentially linked with said first skimmer unit.

9. The protein skimmer of claim 8, wherein said second skimmer unit comprises
a mixing chamber comprising perimeter walls, a foam exit channel at or near the top of said chamber, and a cleaned water exit opening at or near the bottom of said chamber;
an injector configured to inject contaminated water into water in said mixing chamber and cause generation of bubbles in water therein;
a foam collection cup adjacent said foam exit channel arranged to accept foam passing through said foam exit channel.

10. The protein skimmer of claim 1, further comprising a lid, wherein said lid creates separate air volumes around said injector and above said collection cup or foam exit channel.

11. The protein skimmer of claim 7, wherein said foam exit channel deflector is attached to said collection cup.

12. The protein skimmer of claim 1, wherein said injector directs the injected water such that a rotational circulation pattern is established; and
further comprising a foam exit channel deflector positioned such that foam is skimmed from the water in a laterally flowing portion of the circulation pattern and deflected into the foam exit channel.

13. The protein skimmer of claim 1, further comprising a vacuum channel connecting between an air volume about said injector and an air volume above said collection cup.

14. A protein skimmer kit, comprising
a protein skimmer comprising
a mixing chamber comprising perimeter walls, a foam exit channel at or near the top of said chamber, and a cleaned water exit at or near the bottom of said chamber;
an injector configured to inject contaminated water into water in said mixing chamber and cause generation of bubbles in water therein; and
a foam collection cup arranged to accept foam passing through said foam exit channel; and
instructions for use of said protein skimmer or directions for obtaining said instructions for use.

15. The kit of claim 14, further comprising a package containing said protein skimmer and said instructions.

16. The kit of claim 14, further comprising a pump for pumping water through said injector.

17. The kit of claim 14, comprising a protein skimmer of claim 1.

18. A method for removing protein contaminants from protein contaminated water using a protein skimmer, comprising
injecting contaminated water into water in a first mixing chamber in said protein skimmer, wherein said injecting generates foam;
passing said foam through a foam exit channel at or near the top of said mixing chamber;
collecting foam that passes through said foam exit channel in a separate collection tub located adjacent or proximate to said foam exit channel.

19. The method of claim 18, wherein said protein skimmer further comprises a second mixing chamber positioned below said first mixing chamber with an opening between said chambers such that water can exit from said first mixing chamber and enter said second mixing chamber.

20. The method of claim 18, wherein said protein skimmer is as described in claim 1.
